(19) United States
(12) Patent Application Publication
(10) Pub. No.: US 2003/0125916 A1
(43) Pub. Date: Jul. 3, 2003

(54) Simulation and synthesis of metastable flip flops

(76) Inventor: Jeffrey A. Benis, San Jose, CA (US)

Correspondence Address: HEWLETT-PACKARD COMPANY, Intellectual Property Administration, P.O. Box 272400, Fort Collins, CO, 80527-2400, US

(21) Appl. No.: 10/028,654

(22) Filed: Dec. 20, 2001

(51) Int. Cl. G06F 17/50

(52) U.S. Cl. 703/14

(57) ABSTRACT

A method for simulating an array of flip flops including metastable effects. The method can also be used for synthesis. For simulation, a first set of values representing input values for a first rank of flip flops in the array is received. The first set of values includes a bit value for each flip flop in the first rank. An input for each flip flop in a second rank is computed by selecting between a bit value from the first set of values and a bit value from a second set of values, wherein the second set of values represents values previously held in the first rank. Each flip flop in the second rank thus receives a bit value from either the first set or the second set of values. A metastable boundary is thereby simulated between the first and second ranks of the array.

### TECHNICAL FIELD

The present invention relates to simulation and synthesis of circuits. More specifically, the present invention pertains to a method for simulating and synthesizing an array of flip flops, including metastable effects.

### BACKGROUND ART

The phenomenon of a metastable state in flip flops is known in the art. In essence, a metastable state can occur when a flip flop in one clock domain is in communication with a flip flop in another, asynchronous clock domain. If one flip flop is operating at a frequency that is non-harmonious with the frequency at which the other flip flop is operating, then a metastable state can occur in the “downstream” (receiving) flip flop.

Metastable effects are further described with reference to Prior Art FIG. 1. Operating in a known manner, transmitting flip flop 10 outputs a logical bit value (zero or one) on the edge of a clock pulse (e.g., the positive edge) generated by input clock 12. Receiving flip flop 20, also operating in a known manner, samples flip flop 10 on the edge of a clock pulse (e.g., the positive edge) generated by output clock 22. Input clock 12 and output clock 22 operate asynchronously.

The bit values are actually transmitted as voltages; for simplicity of discussion, assume that a value of zero (0) corresponds to 0 volts and a value of one (1) corresponds to 1 volt. A metastable state can be introduced when flip flop 20 samples flip flop 10 when flip flop 10 is transitioning between 0 volts and 1 volt; if this occurs, flip flop 20 will sample a voltage between 0 volts and 1 volt. Thus, flip flop 20 may end up holding an incorrect value or it may propagate the metastability to the next element in the circuit. Ultimately, the reliability and operability of the circuit can be affected, perhaps causing the circuit to fail.

Metastable failures are difficult to diagnose and correct and the metastable state is just as difficult to prevent. Therefore, circuits are designed to accommodate the effects of metastability. An exemplary circuit 50 designed for mitigating metastable effects is illustrated by Prior Art FIG. 2. In circuit 50, a number of receiving flip flops (FFs) 40, 41 and 42 are chained as shown (a number of flip flops other than three may be used). These flip flops are “hardened” to resist a metastable failure. Input clock 35 and output clock 45 operate asynchronously. Transmitting flip flop 30 outputs a voltage on the edge of a clock pulse generated by input clock 35. Receiving flip flop 40 samples flip flop 30, flip flop 41 samples flip flop 40, and flip flop 42 samples flip flop 41 on the edge of a clock pulse generated by output clock 45.

Should flip flop 40 sample a voltage between 0 volts and 1 volt, the chain of flip flops 40, 41 and 42 allows the signal to settle to a legitimate logic value (0 or 1) by the end of the chain. The mechanisms by which this is accomplished are known in the art and will not be described herein. It is sufficient for the purposes of this discussion to know that, to guard against metastable failures, hardened flip flops are chained so that a permissible logic value is achieved by the end of the chain, thereby mitigating the metastable effects induced in the circuit. In general, the more flip flops that are chained, the greater the protection against a metastable failure. However, the use of more flip flops will increase the latency of the circuit because it will take longer for a signal to traverse the length of the flip flop chain, and will consume more of the limited area available on a circuit die.

The prior art is problematic because it is difficult to simulate metastable effects in chains of flip flops. It is particularly difficult for prior art simulation techniques to model the unpredictability of the metastable state. These problems are exacerbated because a circuit will typically include multiple chains of flip flops arranged in parallel to each other. The flip flops are typically coupled to a multi-bit bus (a 32-bit bus, for example). For each bit stream delivered by the bus, there is a corresponding chain of flip flops; thus, for a 32-bit bus, there may be 32 flip flop chains. These flip flop chains are functioning independently of each other, so that a metastable state can occur in any one of the chains at any time without occurring in another chain.

Prior art simulation techniques that attempt to simulate metastable effects in multiple chains of flip flops are complex and take a long time to execute. Assumptions made in the prior art to simplify the simulation and decrease execution time result in mismatches between simulated and true behavior and a loss of accuracy.

Accordingly, what is needed is a method and/or system that can model metastable effects in multiple, independent flip flop chains. What is also needed is a method and/or system that can satisfy the above need using an efficient approach that can be executed quickly without detrimentally affecting the accuracy of the results. The present invention provides a novel solution to these needs.

### DISCLOSURE OF THE INVENTION

The present invention provides a method, and system thereof, for accurately and efficiently modeling metastable effects in multiple, independent flip flop chains. The method and system of the present invention can be used to both simulate and synthesize an array of flip flops.

The flip flop array has a width and a depth, the width representing the number of flip flop chains and the depth representing the number of flip flops, or ranks of flip flops, in the chains. According to the present embodiment of the present invention, for simulation, a metastable boundary is simulated between the first and second ranks of the array. It is appreciated that the metastable boundary can be simulated between any of the ranks in the array. For synthesis, the metastable boundary is in actuality at the input to the first rank of flip flops.

In the present embodiment, a first set of values representing input values for the first rank of flip flops in the array is received. The first set of values includes a bit value for each flip flop in the first rank. An output value for each flip flop in the first rank is computed by selecting between a bit value from the first set of values and a bit value from a second set of values. The second set of values represents values previously held by the flip flops in the first rank, and includes a bit value for each flip flop in the first rank. To clarify, the first set of values includes the values to be sampled by the first rank of flip flops at the next clock pulse, while the second set of values includes the values that were sampled by the first rank of flip flops on a preceding clock pulse.

The output value from each flip flop in the first rank, selected from either the first or second sets of values, is used as the input value for a respective flip flop in the second rank of flip flops in the array. Thus, each flip flop in the second rank receives either the correct input value (from the first set of values) or the value previously held by a respective flip flop in the first rank (from the second set of values). The inputs to the second rank of flip flops are selected on a bit-by-bit basis, so that some bits are correct while others are not. In this way, the metastable effect is simulated on a bit-by-bit basis.

In one embodiment, the present invention is implemented by creating registers to hold the first set of values (e.g., the input or correct bit values), the second set of values (e.g., the values previously held in the first rank), and the inputs to the second rank of flip flops (e.g., the values selected from the first set or the second set of values). These registers are used during simulation but not during synthesis.

In one embodiment, the inputs to the second rank of flip flops are selected based on a random number generator. That is, a random number is generated, and a value from either the first set of values or the second set of values is selected depending on the value of the random number. As such, the metastable state can be randomly introduced in any one of the flip flop chains at any time independent of the other chains.

The present invention allows synthesis to be selectively turned on and off during simulation. The present invention also introduces a feature in which simulation can be selectively turned on and off during synthesis.

In summary, the present invention can be used to simulate the functionality of one or more metastable flip flops. The present invention can also be used to synthesize flip flops. Thus, the same software module can be used for both synthesis and simulation. The present invention accurately and efficiently models metastable effects to reflect true behavior. These and other objects and advantages of the present invention will become obvious to those of ordinary skill in the art after having read the following detailed description of the preferred embodiments that are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

PRIOR ART FIG. 1 is a block diagram of flip flops arranged in an exemplary circuit.

PRIOR ART FIG. 2 is a block diagram showing chains of flip flops in an exemplary circuit.

FIG. 3 is a block diagram of an exemplary computer system upon which aspects of the present invention may be practiced.

FIG. 4A illustrates the simulation of an exemplary array of flip flops according to one embodiment of the present invention.

FIG. 4B illustrates an exemplary clock pulse in accordance with one embodiment of the present invention.

FIG. 5 is a flowchart of a process for simulating an array of flip flops according to one embodiment of the present invention.

### BEST MODE FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing terms such as “receiving,” “computing,” “using,” “selecting,” “simulating,” “synthesizing,” “generating” or the like, refer to the actions and processes of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present invention is also well suited to the use of other computer systems such as, for example, optical and mechanical computers.

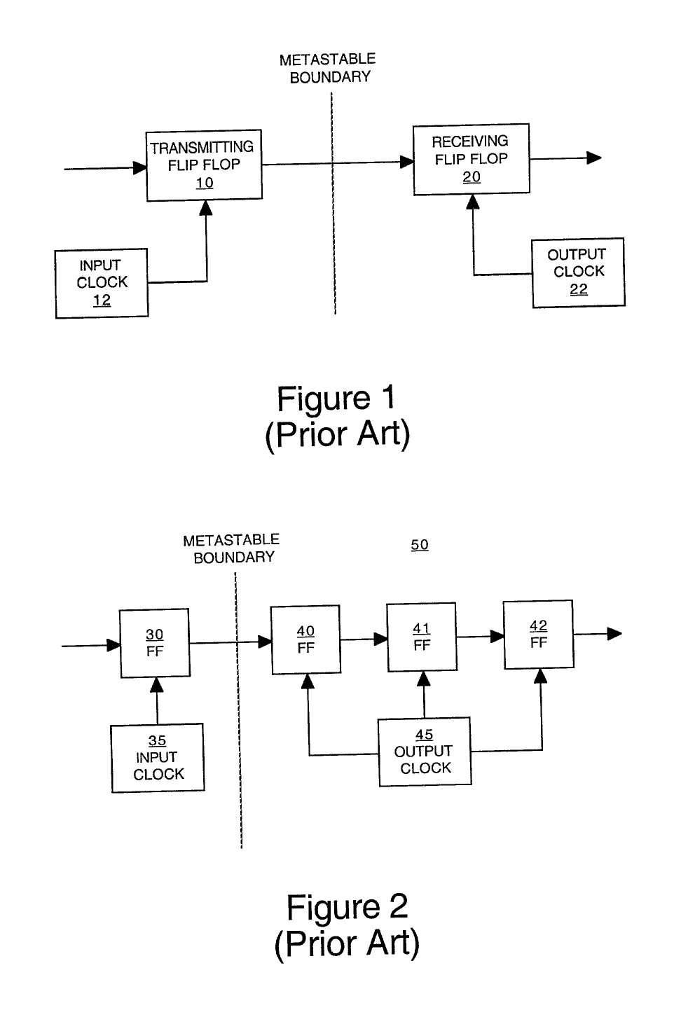

Refer now to FIG. 3, which illustrates an exemplary computer system 190 upon which aspects of the present invention may be practiced. In general, computer system 190 comprises bus 100 for communicating information, processor 101 coupled with bus 100 for processing information and instructions, random access (volatile) memory (RAM) 102 coupled with bus 100 for storing information and instructions for processor 101, read-only (non-volatile) memory (ROM) 103 coupled with bus 100 for storing static information and instructions for processor 101, data storage device 104 such as a magnetic or optical disk and disk drive coupled with bus 100 for storing information and instructions, an optional user output device such as display device 105 coupled to bus 100 for displaying information to the computer user, an optional user input device such as alphanumeric input device 106 including alphanumeric and function keys coupled to bus 100 for communicating information and command selections to processor 101, and an optional user input device such as cursor control device 107 coupled to bus 100 for communicating user input information and command selections to processor 101.

With reference still to FIG. 3, display device 105 utilized with computer system 190 may be a liquid crystal device, cathode ray tube, or other display device suitable for creating graphic images and alphanumeric characters recognizable to the user. Cursor control device 107 allows the computer user to dynamically signal the two-dimensional movement of a visible symbol (pointer) on a display screen of display device 105. Many implementations of the cursor control device are known in the art including a trackball, mouse, joystick or special keys on alphanumeric input device 106 capable of signaling movement of a given direction or manner of displacement. It is to be appreciated that the cursor control 107 also may be directed and/or activated via input from the keyboard using special keys and key sequence commands. Alternatively, the cursor may be directed and/or activated via input from a number of specially adapted cursor directing devices.

Computer system 190 also includes an input/output device 108, which is coupled to bus 100 for providing a physical communication link between computer system 190 and, for example, a network 200. As such, input/output device 108 enables central processor unit 101 to communicate with other electronic systems coupled to the network 200. It should be appreciated that within the present embodiment, input/output device 108 provides the functionality to transmit and receive information over a wired as well as a wireless communication interface (such as an IEEE 802.11b interface). It should be further appreciated that the present embodiment of input/output device 108 is well suited to be implemented in a wide variety of ways. For example, input/output device 108 could be implemented as a modem.

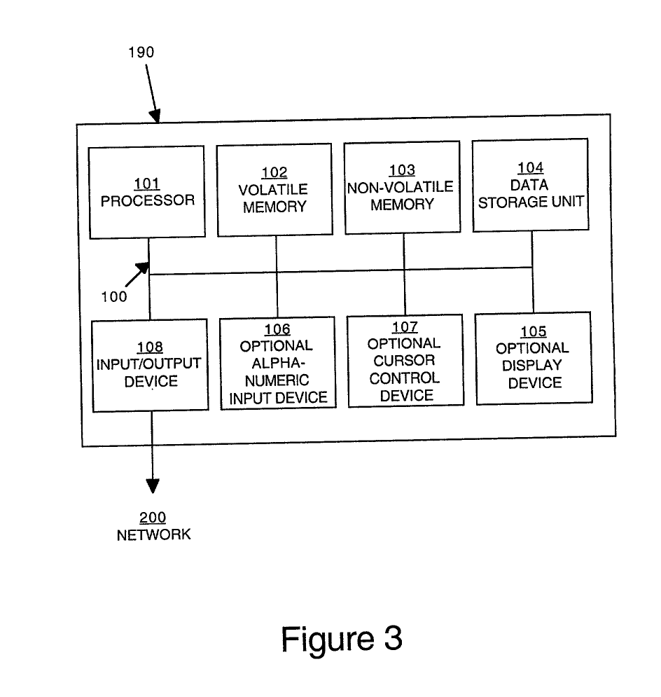

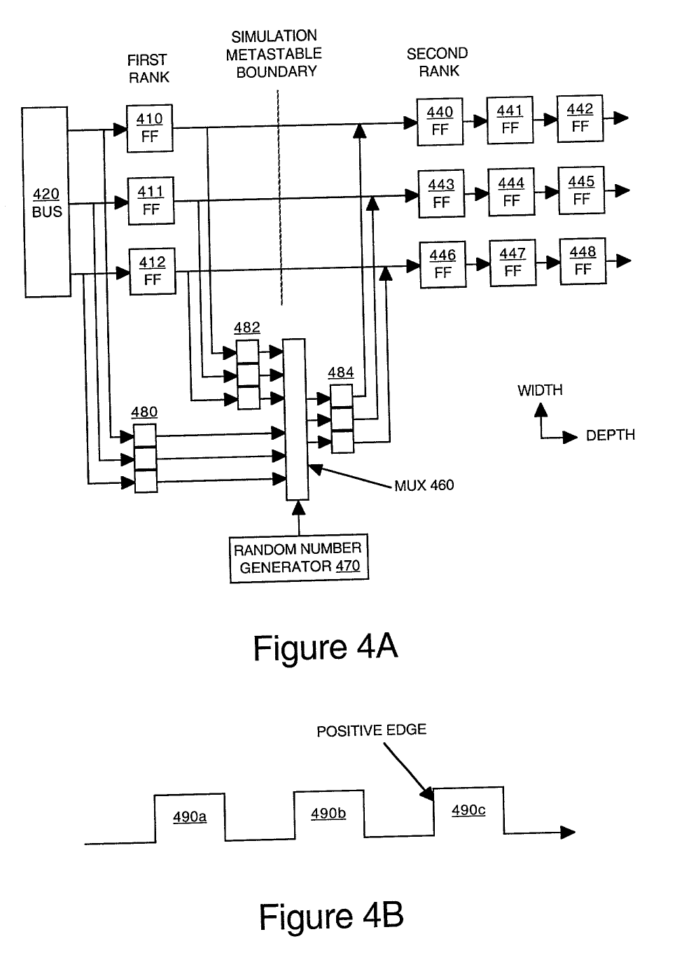

FIG. 4A illustrates the simulation of an exemplary array of flip flops according to one embodiment of the present invention. The array is coupled to a bus 420, and may be a part of a larger circuit that is not shown. The array is comprised of multiple ranks of flip flops and multiple chains of flip flops. In the present embodiment, the number of ranks in the array is prescribed beforehand as a design parameter that depends on factors such as the desired level of protection against metastable effects. In one embodiment, as a matter of design practice, at least three ranks are prescribed; however, the present invention may be used with any number of ranks greater than one.

In the present embodiment, the number of chains in the array is a function of the width of bus 420. That is, bus 420 is typically a multi-bit bus; for example, bus 420 may be a 32-bit bus, in which case the array would typically include 32 chains of flip flops. However, the present invention may be used with a bus of any width or with any number of flip flop chains.

For simplicity of illustration and discussion, the array of flip flops illustrated by FIG. 4A includes four ranks and three chains. According to the present embodiment of the present invention, the array is described as having a depth of four and a width of three; however, it is understood that the dimensions of the array may be differently described. The first rank (also referred to as rank 0) includes flip flops 410, 411 and 412, the second rank (also referred to as rank 1) includes flip flops 440, 443, and 446, and subsequent ranks include flip flops 441, 444 and 447 and flip flops 442, 445, and 448, respectively.

Although the metastable boundary is shown as occurring between the first and second ranks, it will be seen that the metastable boundary can be simulated between any two ranks of flip flops. For synthesis, the metastable boundary is in actuality at the input to the first rank of flip flops.

Tools for simulating and/or synthesizing circuits are known in the art. In the present embodiment, the present invention provides a tool that can be used in conjunction with simulation/synthesis tools. That is, in the present embodiment, the present invention provides a module for modeling metastable effects in an array of flip flops that can be used with existing simulation/synthesis tools.

To simulate the array of flip flops and in particular to model metastable effects, three registers 480, 482 and 484 are defined for simulation of the circuit only (that is, these registers are not used for synthesis of the circuit). In the present embodiment, the registers 480, 482 and 484 are defined in addition to other registers that may be defined for synthesis. The size of the registers 480, 482 and 484 is a function of the width of the array.

In the present embodiment, the simulation of the array with metastable effects also includes a simulated multiplexer (MUX) 460 that receives inputs from registers 480 and 482, multiplexes those inputs, and provides outputs to register 484. In this embodiment, MUX 460 multiplexes the inputs from registers 480 and 482 responsive to a pattern generator. In one embodiment, for simulation, a random number generator 470 is coupled to the simulated MUX 460; however, a random number generator is just one implementation of a pattern generator, and other types of pattern generators may be used. The functionality of the MUX 460 and random number generator 470 is further described below.

According to the present embodiment of the present invention, MUX 460, registers 480, 482 and 484, the pattern generator (e.g., random number generator 470), and the links between these elements, are used for simulation only.

FIG. 4B illustrates exemplary clock pulses 490a, 490b and 490c in accordance with one embodiment of the present invention. In actual practice, data are moved step-wise through the array of flip flops on the occurrence of a clock pulse, specifically on the occurrence of an edge of a clock pulse (e.g., the positive edge). For example, with reference also to FIG. 4A, on the rising (or positive) edge of clock pulse 490a, the first rank of flip flops samples data from bus 420, the second rank samples data from the first rank, and so on. At the next clock pulse 490b (specifically, at the positive edge of clock pulse 490b), this flow of data is repeated, and so on for subsequent clock pulses.

With reference again to FIG. 4A, according to the present embodiment of the present invention, simulation of metastable effects occurs as follows. At the beginning of a simulation step, each of the flip flops 410, 411 and 412 in the first rank of the array holds a certain bit value, either a logical zero (0) or a logical one (1), that was received on an earlier clock edge or that was input to the simulation as an initial value. For simulation, on the next clock edge, bit values representing the values currently held by flip flops 410, 411 and 412 are input to register 482 and bit values representing the input bit values from bus 420 are input to register 480.

Also, a pattern generator generates a pattern that is used by the simulated MUX 460 to select, on a bit-by-bit basis, a value from either register 480 or register 482. In one embodiment, random number generator 470 generates a random number. In this embodiment, MUX 460 selects either the bit value being input to flip flop 410 (represented as the value in the first entry in register 480) or the bit value currently held by flip flop 410 (represented as the value in the first entry in register 482), depending on the random number generated. Similarly, MUX 460 selects from register 480 or from register 482 a bit value for each of the flip flops 411 and 412 in the first rank.

It is appreciated that different types of pattern generators may be used in accordance with the present invention. In one embodiment, the metastable state is induced in simulation in response to a particular (e.g., user-specified) input pattern of bits. For example, the appearance in flip flops 410, 411 and 412 of the specified pattern of bits will cause the metastable state to occur in simulation. In some cases, simulating metastability based on a particular input pattern can provide a more realistic model of true behavior or can simulate a condition known to induce metastable failures.

The selections made by MUX 460 are input to register 484. The values in register 484 represent the inputs to flip flops 440, 443 and 446 in the second rank of flip flops. The selections made by MUX 460, and hence the inputs to the second rank of flip flops, will include some combination of values from register 480 and register 482.

In this manner, metastable effects are simulated by the present invention. If the input value to a flip flop and the value held by the flip flop are the same, then there is no transition from the older value to the newer one, and thus a metastable state will not occur. If the input value to a flip flop is different from the value held by the flip flop (e.g., one value is 0 and the other is 1), then a transition from the older value to the newer value (e.g., from 0 to 1 or from 1 to 0) will occur, and a metastable state is possible. If metastability does occur, the output of the flip flop (and the input to the next flip flop) can be either a 0 or 1 in simulation. This effect is captured by the present invention as described above. Also, the randomness of metastable states is captured by the present invention by using a pattern generator (such as a random number generator) to select one value over another. As described above, values are selected on a bit-by-bit basis, and so the metastable state can be introduced in any one of the flip flop chains at any time independent of the other chains. The present invention thus provides a method for accurately modeling metastable effects to reflect true behavior, particularly for multiple and independent chains of flip flops.

The present embodiment of the present invention is also advantageous because the simulation is based on a single (simulated) clock and because the metastable effect is simulated using clock edges. That is, in actual practice, metastability occurs when a flip flop in one clock domain is in communication with a flip flop in another, asynchronous clock domain and a bit value is sampled when the transmitting flip flop is transitioning from one state to another. However, according to the present invention, it is not necessary to model the two asynchronous clocks in order to introduce a metastable state. Also according to the present invention, it is not necessary to sample the transmitting flip flops (e.g., flip flops in the first rank) while they are between states in order to simulate the metastable case. As a result of these and other features, the present invention can be executed relatively efficiently and quickly.

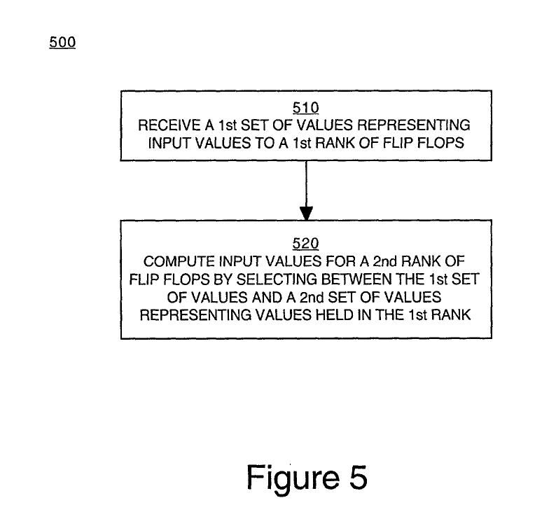

FIG. 5 is a flowchart 500 of a process for simulating an array of flip flops according to one embodiment of the present invention. Flowchart 500 includes processes of the present invention that, in one embodiment, are carried out by a processor (e.g., processor 101 of FIG. 3) under the control of computer-readable and computer-executable instructions. The computer-readable and computer-executable instructions reside, for example, in data storage features such as computer usable volatile memory 102, computer usable non-volatile memory 103, and/or data storage unit 104 of FIG. 3.

Although specific steps are disclosed in flowchart 500 of FIG. 5, such steps are exemplary. That is, the present invention is well suited to performing various other steps or variations of the steps recited in flowchart 500. It is appreciated that the steps described below with reference to flowchart 500 may be performed in an order different than presented, and that not all of the steps described may be performed.

In step 510, in the present embodiment, a first set of values representing input values to a first rank of flip flops in an array is received. An input value is provided for each of the flip flops in the first rank.

In step 520, in the present embodiment, input values for a second rank of flip flops in the array are computed by selecting between the first set of values and a second set of values that represent values currently held by the flip flops in the first rank. The second set of values includes a value for each of the flip flops in the first rank. According to the present invention, for each flip flop in the second rank, an input value is determined by selecting either the respective value from the first set of values or the respective value from the second set of values.

In one embodiment, the inputs to the second rank of flip flops are selected according to a pattern generator or to a specified input pattern of bits. In one embodiment, the inputs to the second rank of flip flops are selected using a random number generator. Depending on the value of a random number that is generated, a value is selected from either the first set of values or the second set of values. As described above, the selection is performed on a bit-by-bit basis.

Table 1 is a listing of code for simulating and synthesizing flip flops, including metastable effects, in accordance with one embodiment of the present invention.

TABLE 1
An Embodiment of Simulation and Synthesis Code
According to the Present Invention

| | |
|---|---|
| 1: | ′timescale 1ns / 10ps |
| 2: | module rsff_sync_ff6 ( in, out, out_clk ); |
| 3: | parameter width = 3, |

| | |
|---|---|
| 4: | depth = 4; |

| | |
|---|---|
| 5: | // translate_off |
| 6: | initial begin |

| | |
|---|---|
| 7: | if (depth < 3) begin |

| | |
|---|---|
| 8: | $display (“ERROR: depth (%d) must be > 2 in %m”, depth); |
| 9: | $finish |

| | |
|---|---|
| 10: | end |

| 11: | end | | |
|---|---|---|---|
| 12: | // translate_on | | |
| 13: | input | [width-1:0] | in; |
| 14: | input | | out_clk; |
| 15: | output | [width-1:0] | out; |
| 16: | reg | [width-1:0] | sync_ff [0:depth-2]; |
| 17: | reg | [width-1:0] | last_sync_ff; |
| 18: | integer | | i |
| 19: | // translate_off | | |
| 20: | reg | [width-1:0] | sync_ff_temp1; |
| 21: | reg | [width-1:0] | sync_ff_temp2; |
| 22: | reg | [width-1:0] | sync_ff_temp0; |
| 23: | integer | | j; |
| 24: | reg | [31:0] | random; |

| 25: | // translate_on | |
|---|---|---|
| 26: | assign | out = last_sync_ff; |

| | |
|---|---|
| 27: | always @ (posedge out_clk) begin |

| 28: | // translate_off | |
|---|---|---|
| 29: | random <= $random(random); | |
| 30: | // translate_on | |
| 31: | sync_ff[0] | <= in; |
| 32: | // translate_off | |
| 33: | sync_ff_temp1 | <= sync_ff[0]; |
| 34: | sync_ff_temp0 | <= in; |

| | |
|---|---|
| 35: | for (j = 0 ; j < width ; j = j+1) begin |
| 36: | sync_ff_temp2[j] = random[j] ? sync_ff_temp1[j] : sync_ff_temp0[j]; |
| 37: | end |
| 38: | if (1′b0) begin // always false, only do this in synthesis |

| | |
|---|---|
| 39: | // translate_on |
| 40: | sync_ff[1] <= sync_ff[0]; |
| 41: | // translate_off |

| | |
|---|---|
| 42: | end |

| | |
|---|---|
| 43: | else sync_ff[1] <= sync_ff_temp2; |
| 44: | // translate_on |

| | |
|---|---|
| 45: | for (i = 2; i < depth-1 ; i = 1+1) sync_ff[1] <= sync_ff[i−1]; |
| 46: | last_sync_ff <= sync_ff[depth-2]; |

| | |
|---|---|
| 47: | end |
| 48: | endmodule |

In the present embodiment, in lines 3 and 4 of Table 1, the dimensions of the array of flip flops are defined. In the present embodiment, the dimensions are user inputs. In this example, the width is defined as “3” and the depth as “4,” indicating that there are three chains of flip flops and four ranks (refer to FIG. 4A). However, as explained previously herein, the present invention can be used for a range of widths and depths.

According to the present invention, synthesis can be selectively turned on and off during simulation so that certain statements are not translated into synthesis. In the present embodiment, this is accomplished using the statements “translate_off” to turn off synthesis, and “translate_on” to turn on synthesis (see lines 5, 12, 19, 25, 28, 30, 32, 39, 41 and 44 of Table 1). These statements may also take the form of “synopsis translate_off” and “synopsis translate_on” in one specific implementation of the present invention. Similar statements known in the art may also be used. Thus, according to the present invention, the same module can be used for both simulation and synthesis.

In the present embodiment, lines 6 and 7 of Table 1 are used to implement a design constraint that the depth be at least equal to three. However, it is understood that this is not a requirement of the present invention, and that the present invention may be implemented without this design constraint (e.g., for depths less than three).

In the present embodiment, lines 13-18 of Table 1 are used to define inputs, outputs and the like for both simulation and synthesis. Lines 20-24 of Table 1 are used to create registers (e.g., registers 480, 482 and 484 of FIG. 4A) for use with simulation only.

Line 27 of Table 1 defines the scheduling time stamps; in the present embodiment, the positive edges of the clock signals are used. According to the present invention, it is not necessary to model asynchronous clocks or different clock domains. Also according to the present invention, it is not necessary to simulate outside of a clock boundary (e.g., a clock edge) in order to simulate metastable effects.

In line 29 of Table 1, for simulation only, a random number is generated according to one embodiment of the present invention. In this embodiment, the random number is generated using as its seed the random number that was generated in the previous clock cycle (at the preceding time stamp). Initially, the variable “random” is zero, so the first random number is generated using a seed of zero. The first random number is used as the seed for generating the next random number, and so on. The advantage of generating random numbers in this manner is that it allows the simulation to be repeated, if desired. It is understood that other mechanisms for generating random numbers may be used.

Lines 31-36 of Table 1 pertain to the movement of data between registers and to the selection of values based on the value of the random number. It is important to recognize that although these lines are listed sequentially, they are executed in parallel at each time stamp (e.g., at each positive clock edge) using techniques known in the art and utilized in hardware description languages such as Verilog. It is also important to recognize that lines 31, 33 and 34 are “non-blocking” statements while line 36 is a “blocking” statement.

According to the present embodiment of the present invention, for simulation only, in lines 33 and 34 (Table 1) the values previously held in the first rank of flip flops (e.g., the values in register sync_if[0]) are input to register sync_ff_temp1 (e.g., register 482 of FIG. 4A), and the input values (e.g., from bus 420) are input to register sync_ff_temp0 (e.g., register 480 of FIG. 4A). In lines 35 and 36 of Table 1, on a bit-by-bit basis, the random number generated in line 29 is used to select between the values in these two registers (the question mark in line 36 represents MUX 460 of FIG. 4A). It is appreciated that other techniques may be used to select between the values in the two registers. In line 36, the selected values are input to register sync_ff_temp2 (e.g., register 484 of FIG. 4A) and also latched into flip flops 440, 443 and 446.

In line 38 of Table 1, according to the present invention, simulation is selectively turned off, and only synthesis is performed. In line 40, for synthesis only, the values from the first rank of flip flops are input to the second rank of flip flops. The present invention thus includes a feature in which simulation can be selectively turned on and off so that only synthesis is performed.

In lines 45 and 46, in the present embodiment, values are input to the other ranks of flip flops (that is, the ranks other than the first and second ranks).

The present invention thus provides a method, and system thereof, for accurately and efficiently modeling metastable effects in multiple, independent flip flop chains. The method and system of the present invention can be used to both simulate and synthesize an array of flip flops.

The preferred embodiment of the present invention, simulation and synthesis of metastable flip flops, is thus described. While the present invention has been described in particular embodiments, it should be appreciated that the present invention should not be construed as limited by such embodiments, but rather construed according to the following claims.

What is claimed is:

1. A method for simulating an array of flip flops including metastable effects, said method comprising:
a) receiving a first set of values comprising a bit value for each flip flop in a first rank of flip flops in said array, wherein said first set of values represents input values for said first rank; and
b) computing an input value for each flip flop in a second rank of flip flops in said array by selecting between a respective bit value from said first set of values and a respective bit value from a second set of values, wherein said second set of values represents bit values previously held by flip flops in said first rank;
wherein said second rank receives a combination of bit values from said first and second sets of values to simulate said metastable effects.

2. The method as recited in claim 1 further comprising:
receiving information defining a width and depth of said array, wherein said width defines the number of flip flops in each rank of said array and wherein said depth defines the number of ranks in said array.

3. The method as recited in claim 2 wherein said array represents a plurality of chains of flip flops, wherein the number of flip flops in a chain corresponds to said depth and wherein the number of chains corresponds to said width.

4. The method as recited in claim 1 wherein said steps a)-b) are performed for each of a plurality of simulated clock pulses.

5. The method as recited in claim 4 wherein said steps a)-b) are performed at an edge of a simulated clock pulse.

6. The method as recited in claim 1 wherein said step b) comprises:
generating a random number based on a seed number; and
selecting between a bit value from said first set of values and a bit value from said second set of values using said random number.

7. The method as recited in claim 6 wherein a random number is generated for each of a plurality of simulated clock pulses, wherein each random number generated is used as a seed number for generating a subsequent random number.

8. The method as recited in claim 1 further comprising:
synthesizing said array of flip flops, wherein said synthesizing is selectively turned on and off during said simulating.

9. The method as recited in claim 8 wherein said simulating is selectively turned on and off during said synthesizing.

10. A computer system comprising:
a bus;
a memory unit coupled to said bus; and
a processor coupled to said bus, said processor for executing a method for simulating an array of flip flops including metastable effects, said method comprising:
a) receiving a first set of values comprising a bit value for each flip flop in a first rank of flip flops in said array, wherein said first set of values represents input values for said first rank; and
b) computing an input value for each flip flop in a second rank of flip flops in said array by selecting between a respective bit value from said first set of values and a respective bit value from a second set of values, wherein said second set of values represents bit values previously held by flip flops in said first rank;
wherein said second rank receives a combination of bit values from said first and second sets of values to simulate said metastable effects.

11. The computer system of claim 10 wherein said method further comprises:
receiving information defining a width and depth of said array, wherein said width defines the number of flip flops in each rank of said array and wherein said depth defines the number of ranks in said array.

12. The computer system of claim 11 wherein said array represents a plurality of chains of flip flops, wherein the number of flip flops in a chain corresponds to said depth and wherein the number of chains corresponds to said width.

13. The computer system of claim 10 wherein said steps a)-b) of said method are performed for each of a plurality of simulated clock pulses.

14. The computer system of claim 13 wherein said steps a)-b) of said method are performed at an edge of a simulated clock pulse.

15. The computer system of claim 10 wherein said step b) of said method comprises:
generating a random number based on a seed number; and
selecting between a bit value from said first set of values and a bit value from said second set of values using said random number.

16. The computer system of claim 15 wherein a random number is generated for each of a plurality of simulated clock pulses, wherein each random number generated is used as a seed number for generating a subsequent random number.

17. The computer system of claim 10 wherein said method further comprises:
synthesizing said array of flip flops, wherein said synthesizing is selectively turned on and off during said simulating.

18. The computer system of claim 17 wherein said simulating of said method is selectively turned on and off during said synthesizing.

19. A computer usable medium having computer readable code stored thereon for causing a computer system to perform a method comprising:
a) receiving a first set of values comprising a bit value for each flip flop in a first rank of flip flops in an array, wherein said first set of values represents input values for said first rank; and
b) computing an input value for each flip flop in a second rank of flip flops in said array by selecting between a respective bit value from said first set of values and a respective bit value from a second set of values, wherein said second set of values represents bit values previously held by flip flops in said first rank;
wherein said second rank receives a combination of bit values from said first and second sets of values to simulate metastable effects.

20. The computer usable medium of claim 19 wherein said computer-readable program code embodied therein causes a computer system to perform a method comprising:
receiving information defining a width and depth of said array, wherein said width defines the number of flip flops in each rank of said array and wherein said depth defines the number of ranks in said array.

21. The computer usable medium of claim 20 wherein said array represents a plurality of chains of flip flops, wherein the number of flip flops in a chain corresponds to said depth and wherein the number of chains corresponds to said width.

22. The computer usable medium of claim 19 wherein said steps a)-b) are performed for each of a plurality of simulated clock pulses.

23. The computer usable medium of claim 19 wherein said steps a)-b) are performed at an edge of a simulated clock pulse.

24. The computer usable medium of claim 19 wherein said computer-readable program code embodied therein causes a computer system to perform a method comprising:
generating a random number based on a seed number; and
selecting between a bit value from said first set of values and a bit value from said second set of values using said random number.

25. The computer usable medium of claim 24 wherein a random number is generated for each of a plurality of simulated clock pulses, wherein each random number generated is used as a seed number for generating a subsequent random number.

26. The computer usable medium of claim 19 wherein said computer-readable program code embodied therein causes a computer system to perform a method comprising:
synthesizing said array of flip flops, wherein said synthesizing is selectively turned on and off.

27. The computer usable medium of claim 26 wherein said steps a)-b) are for simulating said array of flip flops and wherein said simulating is selectively turned on and off during said synthesizing.
